(19) United States
(12) Patent Application Publication
(10) Pub. No.: US 2023/0206018 A1
(43) Pub. Date: Jun. 29, 2023

(54) METHOD FOR PRODUCING AN ELECTRONIC MODULE FOR A SMART CARD WITH SECURITY PATTERNS

(71) Applicant: SMART PARKAGING SOLUTIONS, Rousset (FR)

(72) Inventors: Kevin FABRIZIO, Rousset (FR); Dominique CHARRIE, Rousset (FR)

(73) Assignee: SMART PARKAGING SOLUTIONS, Rousset (FR)

(21) Appl. No.: 17/998,834

(22) PCT Filed: May 19, 2021
(86) PCT No.: PCT/FR2021/000053

§ 371 Date: Nov. 15, 2022

(30) Foreign Application Priority Data
May 20, 2020 (FR) 2005241

(51) Int. Cl. G06K 19/077; G06K 19/10

(52) U.S. Cl. CPC G06K 19/07747; G06K 19/07743; G06K 19/10

(57) ABSTRACT

A method for producing security patterns on an electronic module for a security document includes providing a dielectric film; producing through-holes in the dielectric film; depositing at least one metallic layer on upper and lower faces of the dielectric film leaving the through-holes open; engraving a set of functional metallic zones comprising a central zone forming an electrical ground and a set of electrical contacts separated from one another and separated from the electrical ground by non-metallized zones that expose the dielectric film, and a set of non-functional or decorative zones; and simultaneously engraving a first hollow security pattern by removing material in one of the functional metallic zones, and a second security pattern in relief relative to the dielectric film and obtained by removing material in a zone located outside the functional metallic zones forming the electrical contacts of the terminal block.

The invention relates to microelectronic modules, notably for chip cards, having a terminal block of metal contacts on one of their sides. This may be a module for a contact chip card in the ISO 7816-1 format, or for a hybrid chip card comprising an antenna and operating both in contact mode with a contact reader and in contactless mode with a remote reader. By way of non-limiting example, the invention notably applies to electronic modules for identification cards comprising a security logo.

However, the invention is independent of the size of the base, and the module may be used both for conventional chip cards and for other secure documents provided with a contact electronic module, such as electronic passports, for example, so that, in order to simplify the disclosure, both chip cards in the usual format (according to the ISO 7816-1 standard) and security documents which have another format but are also provided with an electronic module of the type usually used in chip cards in the aforementioned format will be designated by the same term, “chip cards”.

### PRIOR ART

Several types of chip cards provided with a security pattern on the card body or on the surface of the electronic module of the card are already known in the prior art.

Indeed, it has for several years been desirable to provide contact identity chip cards with a security design covering the upper side of the card body and allowing cases of fraud to be detected or limited, but it has been observed that such a security design is not easy to produce on the modules themselves, as the conductivity of the contacts of the modules risks being compromised.

In order to solve this problem in part, the document DE 196 25 466 C1 described a chip card operating by contact with the corresponding contacts of a reader, the contacts of the module themselves being provided with a design, notably of a different specific color from the usual gold or silver color. To this end, the contacts are coated with a metal dispersive layer containing aluminum-based colored particles. However, the contacts remain electrically accessible, this allowing cases of fraud by attacking the circuit of the chip through the contacts of the chip card. Furthermore, the contacts and the module also remain physically accessible and quite easy to replicate with current technologies, this allowing it to be envisaged to remove and to replace the electronic module.

From the U.S. Pat. No. 6,259,035 B1, a contact chip card is also known in which an attempt was made to make the electronic module and the metal contacts as discreet as possible in their appearance, by coloring the contacts themselves and by ensuring that the design of the surface of the module is a continuation of the design of the card body.

An opposite approach was pursued again in the U.S. Pat. No. 5,552,574, which describes, by contrast, the way to provide the surface of the contacts of a contact chip card with a security etching, produced using a laser beam.

It results from the preceding examples that the problem of security markings has been tackled for contact cards either by guilloché or other designs produced on the card body or by graphically altering the metal contacts of the module, in the form of colors or of laser etching produced directly on the contacts.

Moreover, from the document FR 2 777 506 A1, a method is known for producing a decorative entity on a chip card, comprising contact pads located on an electronic module and plates of any shapes which are complementary to the contact pads of the module in order to form a decorative entity. This method is, therefore, purely decorative in scope and is not used for purposes of the security of the chip card against fraud.

In the field of the fight against fraud, from the document EP 2 350 929 A1 a method is known consisting in producing a multitude of holes opening through the card body and the module, so as to make it more difficult to disassemble the card and reassemble it with a counterfeit card body or module.

In the same spirit, the document WO 2005/027020 A1 describes a module for a chip card, the connectors of which comprise one or more micro-holes which are not visible to the naked eye but may be observed with sufficient magnification. This involves particular operations which are incompatible with fast transactions. Furthermore, the micro-holes are produced in functional zones of the connectors and risk interfering with the chip card reader.

The document EP 2 533 175 A1 describes a chip card the module of which comprises, in addition to the electrical contacts, a printed image. The latter may be printed partially on the module and partially on the card body, in order to make it easier to detect fraud by removal of the module.

To manufacture chip cards, it is generally preferable to use reliable and high-yield manufacturing methods, such as the conventional insertion method used for contact cards, consisting in transferring a contact module into a cavity of the body of the card. However, this method as such has low security as cards manufactured in this way are particularly exposed to fraud consisting in extracting the module from the card, this being particularly undesirable for cards or documents intended for identity check applications.

### AIM OF THE INVENTION

One aim of the present invention is, consequently, to propose an electronic module structure for a chip card or another security document, and a method for producing such a module, which are able to mitigate the aforementioned drawbacks.

In particular, one aim of the present invention is to propose a method for producing a module for a chip card, and a module obtained in this way, intended for applications of identity check type, which is more secure while at the same time being easier to manufacture by the official manufacturer with high yields and low costs.

Another aim of the present invention is to allow security designs such as logos or other security patterns to be produced directly on the showing surface of the module, in order to make it more difficult to modify or to replace the electronic module in the context of a fraud attempt.

SUBJECT OF THE INVENTION

To this end, one subject of the invention is a method for producing security patterns on an electronic module for a security document, comprising steps consisting in:
supplying a dielectric film;
producing through holes in the dielectric film;
depositing at least one metal layer on the upper side and the lower side of the dielectric film, leaving said holes open;
delimiting by etching, on the one hand, a set of functional metal zones comprising a central zone forming an electrical ground and a set of electrical contacts separated from one another and separated from the electrical ground by non-metallized zones letting the dielectric film show and, on the other hand, a set of non-functional or decorative zones;
characterized in that it comprises a step consisting in simultaneously producing, by an etching operation, a debossed first security pattern obtained by removing material from one of said functional metal zones and a second security pattern embossed with respect to the dielectric film and obtained by removing material from a zone located outside said functional metal zones forming the electrical contacts of the terminal block.

According to one embodiment of the method, said first security pattern is produced in the central zone forming an electrical ground.

According to one embodiment of the method, said first security pattern is produced by a photochemical etching step removing said at least one metal layer in order to make the contours of said first security pattern appear debossed on the dielectric film.

According to one embodiment of the method, said second security pattern is obtained by photochemical etching locally removing said at least one metal layer in order to make the contours of said second security pattern appear embossed on the dielectric film outside said functional zones.

According to one embodiment, the method according to the invention comprises a complementary step of electrolytically depositing at least one additional silver, gold, nickel or palladium metal layer.

Another subject of the invention is an electronic module for a chip card, comprising a dielectric film provided, on its lower side, with a microelectronic chip, the input/output terminals of which are connected by conductive wires to metal contact pads, and comprising, on its upper side, at least one metal layer comprising a set of functional metal zones forming a terminal block of electrical contacts which are separated by non-metallized zones letting the dielectric film show, the metal contact pads of the lower side being electrically connected to electrical contacts of the terminal block through the holes of the dielectric film, and the electronic module comprising a first security pattern produced debossed in one of said functional metal zones and a second security pattern embossed with respect to the dielectric film and located outside said functional metal zones forming the electrical contacts of the terminal block, characterized in that said first security pattern and said second security pattern are obtained using the method as described above.

According to one practical embodiment of the module, the electrical contacts of the terminal block are standardized contacts which are in accordance with the ISO 7816 standard.

According to one embodiment of the module, said first security pattern is located in a central metal zone of the terminal block corresponding to the electrical ground of the module.

Advantageously, the first security pattern and the second security pattern of the module represent the same shape, optionally at two different scales.

In one variant, the first and the second security pattern of the module represent two complementary shapes which are able to form a composite security element by juxtaposition of the first and second security element.

According to one embodiment of the module, the two security patterns represent complementary alphanumeric characters together forming a unique security code or expression.

According to one embodiment of the module, the two security patterns are two distinct parts of an image or of a logo, so that the juxtaposition of the two graphical security elements allows the complete logo or image to be reconstructed.

Another subject of the invention is chip cards or security documents comprising a base and an innovative module as described hereinabove.

### DETAILED DESCRIPTION

Other features and advantages of the invention will become apparent upon reading the detailed description and the appended drawings, in which:

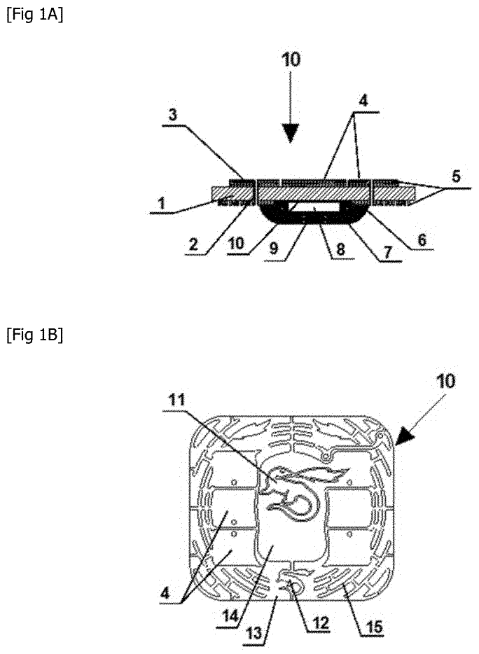

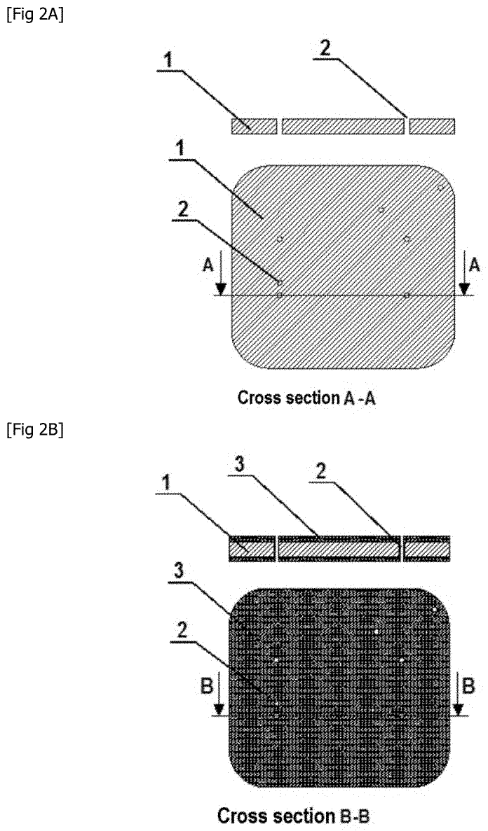

FIGS. 1A and 1B show a cross-sectional and plan view, respectively, of a module for a contact chip card, the showing surface of which comprises at least two graphical security elements according to the invention;

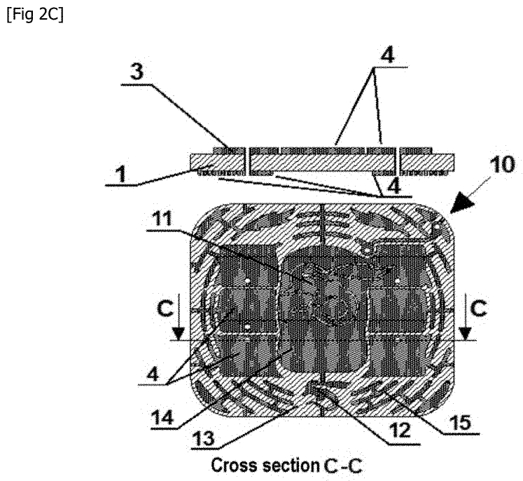

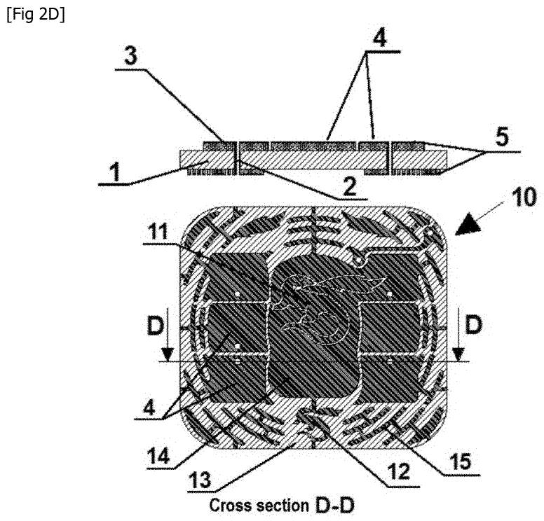

FIGS. 2A to 2D show cross-sectional and plan views of a module for a chip card in various stages of the method for manufacturing a module according to the invention.

Reference is made to FIG. 1. In this figure, an electronic module 10 according to the invention is shown in a cross-sectional view in FIG. 1A and in a plan view in FIG. 1B. It comprises a dielectric film 1 provided, on its lower side, with a microelectronic chip 8 protected by an encapsulating resin droplet 9. The input/output terminals of the microelectronic chip 8 are connected by conductive wires 7 to metal contact pads 6. The dielectric film 1 comprises, on its upper side, at least one metal layer having a set of metal zones forming a terminal block of electrical contacts 4, 14 separated by non-metallized zones 13 locally letting the upper side of the dielectric film 1 show. In the case of a module for a chip card, the electrical contacts 4, 14 of the terminal block are, for example, standardized contacts according to the ISO 7816 standard.

The contact pads 6 of the lower side of the module are connected to electrical contacts 4, 14 of the terminal block by electrically conductive holes 2, for example vias passing through the dielectric film 1 from side to side. This electronic module structure is known as such. It allows the module 10 to be transferred into a cavity of a base such as a chip card body, leaving the upper side of the module, bearing the contacts 4, 14, showing.

In order to increase the security of the final product, it is known practice to mark the upper side with a security marking attesting to its origin, for example etching in the central metal zone 14, corresponding to removing a small amount of metal material revealing a shape or a logo corresponding to the manufacturer or to the issuer of the chip card bearing the module. The marking thus produced corresponds to a debossed pattern in the zone of the contacts of the terminal block, typically in the central zone 14 of the terminal block corresponding to the electrical ground of the module.

Now, it is still quite easy, with currently available tools, to forge such markings after the fact, in order to obtain a fraudulent module. The fraud is typically accomplished by laser etching, yet laser does not allow a pattern to be added by adding material.

In order to mitigate this problem, the invention envisages producing a second graphical security pattern on the surface of the module, outside the zone of the electrical contacts 4, 14, namely in a non-functional zone comprising non-functional, purely decorative, metal elements 15. These metal elements 15 are interconnected among themselves and to the electrical ground 14 of the module. They constitute residual metal elements, embossed with respect to the surface of the dielectric film 1. The invention therefore envisages using one or more of these decorative metal elements 15 to produce a second graphical security pattern 12, embossed with respect to the dielectric film.

There are several options for making it clear, by simple visual examination, that this is a second security pattern 12 which is complementary to the first security pattern 11. For this, it suffices for the embossed shape of the second security pattern 12 to be identical or complementary, to within a scale factor, to the shape of the first security pattern 11. This may then be a logo, an alphanumeric symbol, or any other distinctive image.

By way of exemplary embodiment, said first security pattern 11 and said second security pattern 12 may represent two complementary shapes which are able to form a composite security element by juxtaposition of the first security element and the second security element. This may notably be complementary alphanumeric characters together forming a unique security code or expression.

In one variant, the two security patterns 11, 12 may be two distinct parts of an image or of a logo, so that the juxtaposition of the two graphical security elements 11, 12 allows the complete logo or image to be reconstructed.

It is also possible, if the available space at the periphery of the zone of the contacts 4, 14 of the module allows, to produce two or more second security patterns 12, which are complementary to a first security pattern 11 arranged at the center of the module.

The extra security obtained by virtue of the invention resides in the fact that the second security pattern 12 embossed with respect to the dielectric film 1 is produced as soon as the module is manufactured. Also, it would be very difficult to reproduce such a security pattern 12 after the fact in a previously etched zone 13 of the periphery of the module, letting the dielectric film show, as it is very difficult, even impossible, to locally add a second metal security pattern by means of lamination, while the whole of the metal surface of the module is normally obtained in a single electrolytic deposition operation, followed by an electrochemical etching operation.

The method which allows security patterns 11, 12 to be obtained on the electronic module 10 according to the invention will now be described in more detail in connection with FIG. 2. The steps connected to transferring and connecting the chip 8, which are well known in themselves, will not be described.

As shown in FIG. 2A, to start with a dielectric film 1 is supplied, in which through holes 2 are produced which will later be metallized in order to form vias electrically connecting the two sides of the future module.

Then, as shown in FIG. 2B, a first metal layer 3 is deposited on the upper side and on the lower side of the dielectric film 1, leaving said holes 2 open. This is typically performed by electrolytic deposition, typically of copper, on the two sides of the dielectric film.

The metal surfaces are then photochemically etched in order to delimit contacts 4, 14, 6 on the sides of the module. From the upper side, metal material is removed so as to delimit zones 4, 14, 15 which remain metallized, and zones 13 which let the upper surface of the dielectric film 1 show. The metal zones preserved delimit functional zones 4, 14 of the ISO 7816 contacts, namely 5 contacts 4 and a central electrical ground zone 14, and purely decorative residual metal zones 15 without a particular function. The various functional electrical contacts 4, 14 are de-short-circuited as a result of the electrochemical etching. The decorative metal zones 15 are typically interconnected among themselves and connected to the central electrical ground zone 14.

As visible in FIG. 2C, the method according to the invention comprises a step consisting in producing, using electrochemical etching, a negative first security pattern 11 obtained by removing material from one of said functional metal zones 4, 14, and a second security pattern 12 which is an embossed metal residue and which is located outside the functional metal zones 4, 14 forming the electrical contacts of the terminal block.

According to one embodiment shown, the first security pattern 11 is produced in the central zone 14 forming an electrical ground. This first security pattern 11 is notably etched by means of a photochemical method removing the matter from the metal layer as far as the level of the dielectric film 1, in order to make the contours of the first security pattern 11 appear debossed on the dielectric film, the image of a salamander in the example shown.

The second security pattern 12 is etched simultaneously by removing metal from the non-functional zone 13 which is peripheral to the zone of the ISO contacts 4, 14, so as to make the contours of said second security pattern 12 appear embossed on the dielectric film 1 outside the functional zones 4, 14.

These etching operations may thus be performed very efficiently simultaneously, whereas it would be very difficult, even impossible, to produce a second pattern 12 after the fact by adding material in the context of a fraud attempt. The same etching operation therefore produces a debossed shape 11 located at the center of the module and an embossed shape 12 at the periphery of the module. The correspondence between the two patterns 11, 12 thus obtained is chosen to attest that the two patterns are graphical security patterns produced by the official manufacturer of the module.

As shown in FIG. 2D, it is possible to add other metal layers after the fact on top of the residual first copper layer, either in order to increase the mechanical resistance of the ISO contacts, increase their electrical conductivity, or simply in order to improve their appearance.

Thus, it is possible to add one or more silver, gold, nickel or palladium layers by electrolytic deposition. Electrolytic deposition allows only the copper zones which remain after etching (including the second security pattern) to be coated, without impacting the previously etched zones letting the surface of the dielectric film 1 show.

### ADVANTAGES OF THE INVENTION

The invention achieves the aims set, and proposes a new method for producing a contact or hybrid contact/contactless electronic module, provided with at least two complementary security patterns, which it is possible to produce in good technical and economic conditions only at the stage of the industrial manufacture of the module.

As the two security patterns are produced simultaneously in the context of the method, one debossed in the zone of the metal contacts and the other one embossed outside this zone, the manufacturing method according to the invention allows both very simple and economical production of the modules on mass production lines and production which is very difficult in an artisanal manner after the fact.

The extra security allowed by the invention comes from the fact that a first security pattern is debossed with respect to the metal layer, while the second pattern is embossed with respect to the dielectric. Now, it is very difficult, even impossible, to commit fraud by adding a second embossed pattern after the fact to a dielectric which did not initially comprise one. This would be impossible with the laser methods typically used by fraudsters, as lasers can only remove material, not add it. Also, it would be very difficult to obtain the same result as the invention by means of methods for adding a second pattern after the fact by locally adhesively bonding several metal layers to a zone of the dielectric.

Consequently, the module and the method according to the invention allow the resistance to fraud of these modules, and of the chip cards which bear them, to be substantially strengthened.

Furthermore, as the graphical security elements are produced at the visible surface of the electronic module, this module becomes particularly simple to use and to inspect by means of just a visual check with the naked eye.

1. A method for producing security patterns on an electronic module for a security document, comprising steps of:
supplying a dielectric film;
producing through holes in the dielectric film;
depositing at least one metal layer on an upper side and a lower side of the dielectric film, leaving said holes open;
delimiting by etching, on one hand, a set of functional metal zones comprising a central zone forming an electrical ground and a set of electrical contacts separated from one another and separated from the electrical ground by non-metallized zones letting the dielectric film show and, on the other hand, a set of non-functional or decorative zones; and
simultaneously producing, by an etching operation, a debossed first security pattern obtained by removing material from one of said functional metal zones and a second security pattern embossed with respect to the dielectric film and obtained by removing material from a zone located outside said functional metal zones forming the electrical contacts of the terminal block.

2. The method as claimed in claim 1, wherein said first security pattern is produced in the central zone forming an electrical ground.

3. The method as claimed in claim 1, wherein said first security pattern is produced by a photochemical etching step removing said at least one metal layer in order to make the contours of said first security pattern appear debossed on the dielectric film.

4. The method as claimed in claim 1, wherein said second security pattern is obtained by photochemical etching locally removing said at least one metal layer in order to make the contours of said second security pattern appear embossed on the dielectric film outside said functional zones.

5. The method as claimed in claim 1, further comprising a complementary step of electrolytically depositing at least one additional silver, gold, nickel or palladium metal layer.

6. An electronic module for a chip card, comprising a dielectric film provided, on its lower side, with a microelectronic chip, having input/output terminals which are connected by conductive wires to metal contact pads, and comprising, on its upper side, at least one metal layer comprising a set of functional metal zones forming a terminal block of electrical contacts which are separated by non-metallized zones letting the dielectric film show, the metal contact pads of the lower side being electrically connected to electrical contacts of the terminal block through the holes of the dielectric film, and the electronic module comprising a first security pattern produced debossed in one of said functional metal zones and a second security pattern embossed with respect to the dielectric film and located outside said functional metal zones forming the electrical contacts of the terminal block, wherein said first security pattern and said second security pattern are obtained using the method as claimed in claim 1.

7. The electronic module as claimed in claim 6, wherein the two security patterns represent the same shape.

8. The electronic module as claimed in claim 7, wherein the two security patterns represent the same shape at two different scales.

9. The electronic module as claimed in claim 6, wherein said first security pattern is located in a central metal zone of the terminal block corresponding to the electrical ground of the module.

10. The electronic module as claimed in claim 6, wherein said first security pattern and said second security pattern represent two complementary shapes which form a composite security element by juxtaposition of the first security pattern and the second security pattern.

11. The electronic module as claimed in claim 10, wherein the two security patterns represent complementary alphanumeric characters together forming a unique security code or expression.

12. The electronic module as claimed in claim 10, wherein the two security patterns are two distinct parts of an image or of a logo, so that the juxtaposition of the two graphical security elements allows the complete logo or image to be reconstructed.

13. A chip card, comprising an electronic module as claimed in claim 6.
